(19) United States
(12) Patent Application Publication
(10) Pub. No.: US 2016/0188066 A1
(43) Pub. Date: Jun. 30, 2016

(54) Force Correction on Multiple Sense Elements

(71) Applicant: Apple Inc., Cupertino, CA (US)

(72) Inventor: Shahrooz Shahparnia, Cupertino, CA (US)

(21) Appl. No.: 14/743,476

(22) Filed: Jun. 18, 2015

Related U.S. Application Data
(63) Continuation of application No. 14/417,163, filed on Jan. 25, 2015, now abandoned.
(60) Provisional application No. 61/676,291, filed on Jul. 26, 2012.

(51) Int. Cl. G06F 3/041; G06F 3/044

(52) U.S. Cl. CPC G06F 3/0414; G06F 3/044

(57) ABSTRACT

An electronic device can include a touch device that includes one or more force sensors. The one or more force sensors can include one or more force sensing elements. The one or more force sensing elements can be adapted to provide one or more signals with respect to a force applied to the touch device. One or more processors can be adapted to determine a corrected signal for at least one of the one or more signals when a force is applied at one or more locations that are not directly aligned with at least one force sensing element.

### CROSS-REFERENCE TO RELATED APPLICATION

The present application claims the benefit under 35 U.S.C. §119(e) to U.S. Provisional Patent Application No. 61/676,291, which was filed on Jul. 26, 2012, and entitled “Ultrasonic Force Correction On Multiple Sense Elements,” which is incorporated by reference as if fully disclosed herein.

### BACKGROUND

1. Technical Field

This application generally relates to electronic devices, and more particularly to force measurement in electronic devices.

2. Background

Touch devices generally provide for identification of positions where the user touches the device, including movement, gestures, and other effects of position detection. For a first example, touch devices can provide information to a computing system regarding user interaction with a graphical user interface (GUI), such as pointing to elements, reorienting or repositioning those elements, editing or typing, and other GUI features. For a second example, touch devices can provide information to a computing system suitable for a user to interact with an application program, such as relating to input or manipulation of animation, photographs, pictures, slide presentations, sound, text, other audiovisual elements, and otherwise.

Some touch devices can indicate an amount of force applied when manipulating, moving, pointing to, touching, or otherwise interacting with, a touch device. For a first example, some touch devices allow the user to be able to manipulate a screen element or other object in a first way with a relatively lighter touch, or in a second way with a relatively more forceful or sharper touch. For a second example, some touch devices allow user to be able to move a screen element or other object with a relatively lighter touch, while the user can alternatively invoke or select that same screen element or other object with a relatively more forceful or sharper touch.

Sometimes a user may apply force, or otherwise contact, the touch device at a location which is not directly aligned with a force sensor. For a first example, in a touch device having a grid of force sensors, the user can apply force to the touch device at a location in between two force sensors, or otherwise aligned so that a single force sensor does not measure the entire force applied by the user. For a second example, when the user both applies force and also moves the position at which they are applying force, force sensors which are measuring the force applied by the user generally change as that position is moved. This can have the effect that no individual force sensor is fully activated, and the touch device does not properly measure the amount of force applied by the user.

Each of these examples, as well as other possible considerations, can cause one or more difficulties for the touch device, at least in that determining an amount of force applied to the touch device can be inaccurate. Inaccurate force measurements can cause, for example, a GUI or an application program to improperly provide functions relating to force of touch. When such functions are called for, improperly providing those functions may subject the touch device to lesser capabilities, to the possible detriment of the effectiveness and value of the touch device.

### SUMMARY

In one aspect, an electronic device can include a touch device and one or more processors. The touch device can include one or more force sensors, where the force sensors can include one or more force sensing elements. The one or more force sensing elements are adapted to provide one or more signals with respect to a force applied to the touch device. The one or more processors can be adapted to determine a corrected signal for at least one of the one or more signals when a force is applied at one or more locations that are not directly aligned with the force sensing elements. A force may not be directly aligned with a force sensing element, for example, when the force is applied at an edge or off-center (e.g., a portion) of the force sensing element.

In another aspect, the electronic device can include one or more touch sensors, where the touch sensors can include one or more touch sensing elements.

In another aspect, at least one force sensor can include an ultrasonic force sensor, where the ultrasonic force sensor includes an ultrasonic pulse detector and an ultrasonic pulse generator adapted to emit ultrasonic pulses. At least one signal from a force sensing element can include a signal measuring a reflected ultrasonic pulse.

In another aspect, a method of operating a touch device can include receiving a signal for a force applied to a force sensing element and determining a location for the force applied to the force sensing element. A determination is made as to whether the force applied to the force sensing element is in alignment with the force sensing element based on the determined location. If the force is not in alignment with the force sensing element, the signal for the force applied to the force sensing element can be corrected. A force may not be directly aligned with a force sensing element, for example, when the force is applied at an edge or off-center (e.g., a portion) of the force sensing element.

In another aspect, at least one force sensing element can include an ultrasonic force sensor that includes an ultrasonic pulse detector and an ultrasonic pulse generator adapted to emit ultrasonic pulses. Determining a signal for a force applied to a force sensing element can include measuring a reflected ultrasonic pulse for a force applied to a force sensing element.

In another aspect, a method of operating a touch device can include receiving one or more signals for a force applied to the touch device, and receiving one or more locations for the force applied to the touch device. A determination can be made as to whether the force applied to the touch device is in alignment with one or more force sensing elements based on the one or more locations. If the force is not in alignment with at least one force sensing element, at least one signal for the force applied to the touch device can be corrected. The one or more signals and the at least one corrected signal are combined, and a measure of applied force can be determined in response to the combined signals.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 shows a conceptual drawing of communication between a touch I/O device and a computing system.

FIG. 2 shows a conceptual drawing of a system including a fingerprint recognition device.

FIG. 3A shows a first conceptual drawing of an applied force being moved from a first location to a second location on a touch device.

FIG. 3B shows a second conceptual drawing of an applied force being moved from a first location to a second location on a touch device.

FIG. 4A shows a conceptual drawing of a relationship between an area of applied force to a responsive signal from a force sensing element.

FIG. 4B shows a conceptual drawing of a relationship between a signal from a force sensing element and a measurement of applied force.

FIG. 5A shows a conceptual drawing of an uncorrected measure of force applied to a touch device.

FIG. 5B shows a conceptual drawing of a corrected measure of force applied to a touch device.

FIG. 6 shows a conceptual drawing of a method of operation.

### DETAILED DESCRIPTION

### Overview

This application provides techniques, including circuits and designs, which can determine a correct amount of force applied by a user when that force is applied at one or more locations that are not directly aligned with force sensors. By way of example only, the force can be applied with the user's finger or fingers or with a stylus. In one embodiment, the amount of force applied is measured when a user contacts a touch recognition device. Devices, such as force sensitive sensors, which measure the amount of force, can be incorporated into devices using touch recognition, such as touch pads, touch screens, or other touch devices. For example, a force sensitive sensor can include an ultrasound device which can detect a measure of how forcefully a user is pressing, pushing, or otherwise contacting a touch device. One or more processors or electronic device can adjust that measure in response to locations at which the user is contacting the touch device.

In one embodiment, techniques can include providing a force sensitive sensor including more than one force sensing element incorporated into a touch device. One or more processors or an electronic device can determine an amount of an applied force when that force is applied at one or more locations that are not directly aligned with those force sensing elements, and can determine a combined force applied to a set of nearby force sensing elements.

In one embodiment, when the user contacts the touch device (e.g., with a finger or a conductive stylus) at a location which is not aligned with those force sensing elements, such as a location which overlaps more than one such force sensing element, the force sensitive sensor can measure a signal responsive to an amount of force at each force sensing element, can determine a fraction of the actual amount of force at each sense element, can adjust the measured amount of force at each sense element in response to that fraction, and can combine the actual amount of force at each sense element to provide a total amount of force being applied by the user. For example, the touch device can include a force sensing sensor having one or more force sensing elements disposed in a set of rows and columns. This has the effect that force applied by the user is directly aligned with a force sensor if that force is applied at a location of one of those force sensing elements, and is not directly aligned with a force sensor if that force is applied somewhere other than at one of those force sensing elements, or if that force is applied in conjunction with movement along a surface of the touch device.

In one embodiment, techniques can include using a touch sensor to provide information regarding one or more locations at which a force is being applied. For example, the location sensor can include a capacitive touch sensor including one or more touch sensing elements, which can determine one or more touched locations in response to those touch sensing elements, and which can determine a primary touch location, or a center of touch, in response to those touch sensing elements. In one embodiment, a capacitive touch sensor can determine which touch sensing elements is receiving the applied force. The force sensor can responsively determine an amount of force applied at each of those locations.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### Terminology

The following terminology is exemplary, and not intended to be limiting in any way.

The text “touch sensing element”, and variants thereof, generally refers to one or more data elements of any kind, including information sensed with respect to individual locations. For example and without limitation, a touch sensing element can include data or other information with respect to a relatively small region of where a user is contacting a touch device.

The text “force sensing element”, and variants thereof, generally refers to one or more data elements of any kind, including information sensed with respect to force-of-touch, whether at individual locations or otherwise. For example and without limitation, a force sensing element can include data or other information with respect to a relatively small region of where a user is forcibly contacting a device.

The text “applied force”, “force of touch”, and variants thereof, generally refers to a degree or measure of an amount of force being applied to a device. The degree or measure of an amount of force need not have any particular scale; for example, the measure of force-of-touch can be linear, logarithmic, or otherwise nonlinear, and can be adjusted periodically (or otherwise, such as aperiodically, or otherwise from time to time) in response to one or more factors, either relating to force-of-touch, location of touch, time, or otherwise.

After reading this application, those skilled in the art would recognize that these statements of terminology would be applicable to techniques, methods, physical elements, and systems (whether currently known or otherwise), including extensions thereof inferred or inferable by those skilled in the art after reading this application.

### Force Sensitive Device and System

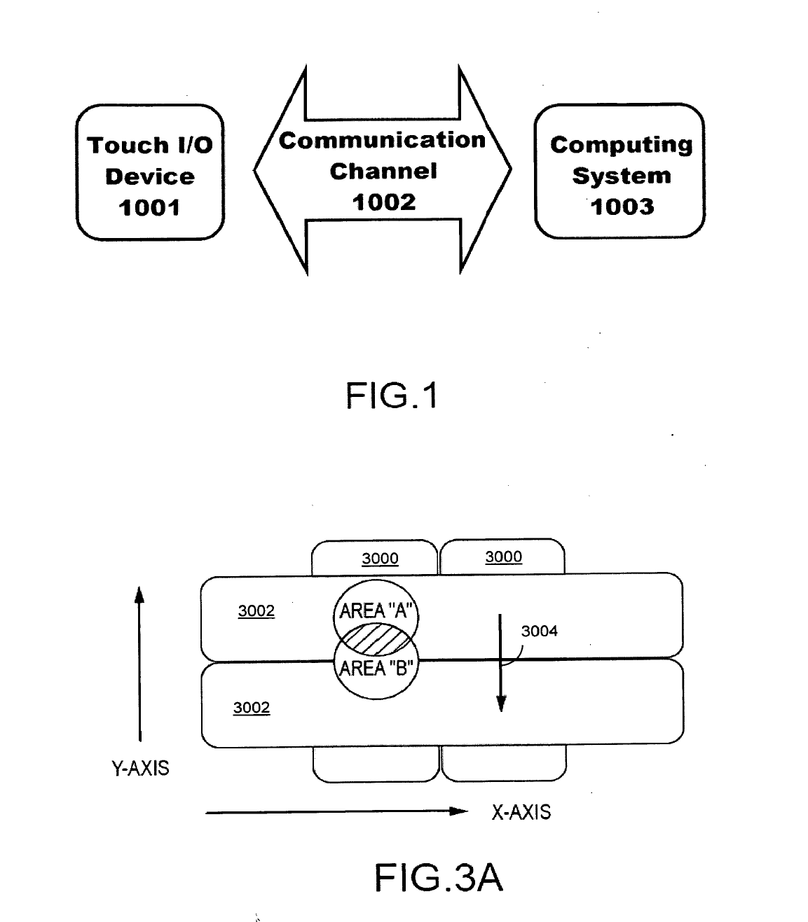

FIG. 1 shows a conceptual drawing of communication between a touch I/O device and a computing system.

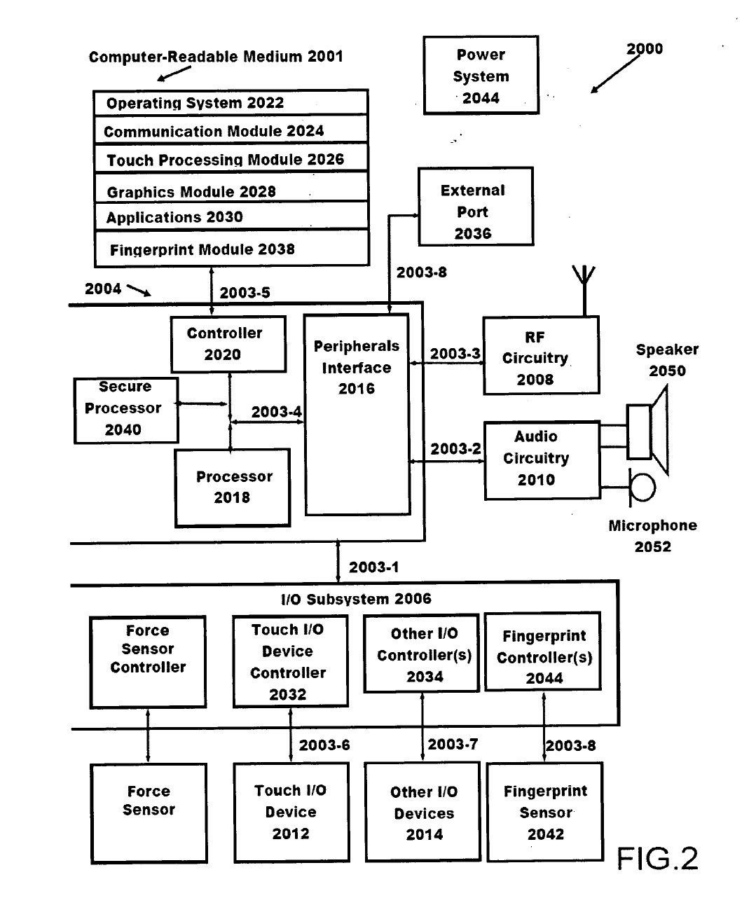

FIG. 2 shows a conceptual drawing of a system including a force sensitive touch device.

Described embodiments may include touch I/O device 1001 that can receive touch input and force input (such as possibly including touch locations and force of touch at those locations) for interacting with computing system 1003 (such as shown in the FIG. 1) via wired or wireless communication channel 1002. Touch I/O device 1001 may be used to provide user input to computing system 1003 in lieu of or in combination with other input devices such as a keyboard, mouse, or possibly other devices. In alternative embodiments, touch I/O device 1001 may be used in conjunction with other input devices, such as in addition to or in lieu of a mouse, trackpad, or possibly another pointing device. One or more touch I/O devices 1001 may be used for providing user input to computing system 1003. Touch I/O device 1001 may be an integral part of computing system 1003 (e.g., touch screen on a laptop) or may be separate from computing system 1003.

Touch I/O device 1001 may include a touch sensitive and force sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard, disposed on a trackpad or other pointing device), any multi-dimensional object having a touch sensitive surface for receiving touch input, or another type of input device or input/output device.

In one example, touch I/O device 1001 is implemented as a touch screen that includes a transparent and/or semitransparent touch sensitive and force sensitive panel at least partially or wholly positioned over at least a portion of a display. According to this embodiment, touch I/O device 1001 functions to display graphical data transmitted from the computing system 1003 (and/or another source) and also functions to receive user input. Although the touch sensitive and force sensitive panel is described as at least partially or wholly positioned over at least a portion of a display, in alternative embodiments, at least a portion of circuitry or other elements used in embodiments of the touch sensitive and force sensitive panel may be at least positioned partially or wholly positioned under at least a portion of a display, interleaved with circuits used with at least a portion of a display, or otherwise. Additionally or alternatively, in other embodiments, touch I/O device 1001 may be embodied as an integrated touch screen where touch sensitive and force sensitive components/devices are integral with display components/devices. In still other embodiments a touch screen may be used as a supplemental or additional display screen for displaying supplemental or the same graphical data as a primary display and to receive touch input, including possibly touch locations and force of touch at those locations.

Touch I/O device 1001 may be configured to detect the location of one or more touches or near touches on device 1001, and where applicable, force of those touches, based on capacitive, resistive, optical, acoustic, inductive, mechanical, chemical, or electromagnetic measurements, in lieu of or in combination or conjunction with any phenomena that can be measured with respect to the occurrences of the one or more touches or near touches, and where applicable, force of those touches, in proximity to device 1001. Software, hardware, firmware or any combination thereof may be used to process the measurements of the detected touches, and where applicable, force of those touches, to identify and track one or more gestures. A gesture may correspond to stationary or non-stationary, single or multiple, touches or near touches, and where applicable, force of those touches, on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, consecutively, or otherwise. A gesture may be characterized by, but is not limited to a pinching, sliding, swiping, rotating, flexing, dragging, tapping, pushing and/or releasing, or other motion between or with any other finger or fingers, or any other portion of the body or other object. A single gesture may be performed with one or more hands, or any other portion of the body or other object by one or more users, or any combination thereof.

Computing system 1003 may drive a display with graphical data to display a graphical user interface (GUI). The GUI may be configured to receive touch input, and where applicable, force of that touch input, via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs or dials, virtual buttons, virtual levers, any virtual UI, and the like. A user may perform gestures at one or more particular locations on touch I/O device 1001 which may be associated with the graphical elements of the GUI. In other embodiments, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input, and where applicable, force of that touch input, on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches, and where applicable, force of those touches, on touch I/O device 1001. Feedback may be transmitted optically, mechanically, electrically, olfactory, acoustically, haptically, or the like or any combination thereof and in a variable or non-variable manner.

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other (portable or non-portable) system or device adaptable to the inclusion of system architecture 2000, including combinations of two or more of these types of devices. FIG. 2 is a block diagram of one embodiment of system 2000 that generally includes one or more computer-readable mediums 2001, processing system 2004, Input/Output (I/O) subsystem 2006, electromagnetic frequency (EMF) circuitry (such as possibly radio frequency or other frequency circuitry) 2008 and audio circuitry 2010. These components may be connected by one or more communication buses or signal lines 2003. Each such bus or signal line may be denoted in the form 2003-X, where X can be a unique number. The bus or signal line may carry data of the appropriate type between components; each bus or signal line may differ from other buses/lines, but may perform generally similar operations.

It should be apparent that the architecture shown in FIGS. 1-2 is only one example architecture of system 2000, and that system 2000 can have more or fewer components than shown, or a different configuration of components. The various components shown in FIGS. 1-2 can be implemented in hardware, software, firmware or any combination thereof, including one or more signal processing and/or application specific integrated circuits.

EMF circuitry 2008 can be used to send and receive information over a wireless link or network to one or more other devices and includes well-known circuitry for performing this function. EMF circuitry 2008 and audio circuitry 2010 are connected to processing system 2004 via peripherals interface 2016. Interface 2016 can include various known components for establishing and maintaining communication between peripherals and processing system 2004. Audio circuitry 2010 is connected to audio speaker 2050 and microphone 2052 and includes known circuitry for processing voice signals received from interface 2016 to enable a user to communicate in real-time with other users. In some embodiments, audio circuitry 2010 includes a headphone jack (not shown).

Peripherals interface 2016 connects the input and output peripherals of the system to processor 2018 and computer-readable medium 2001. One or more processors 2018 can communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 can run various software components stored in medium 2001 to perform various functions for system 2000. In some embodiments, the software components can include operating system 2022, communication module (or set of instructions) 2024, touch and force-of-touch processing module (or set of instructions) 2026, graphics module (or set of instructions) 2028, one or more applications (or set of instructions) 2030, and fingerprint sensing module (or set of instructions) 2038. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments. In some embodiments, medium 2001 can store a subset of the modules and data structures identified above. Furthermore, medium 2001 may store additional modules and data structures not described above.

Operating system 2022 can includes various procedures, sets of instructions, software components and/or drivers for controlling and managing general system tasks (e.g., memory management, storage device control, power management, etc.). Operating system 2022 can facilitate communication between various hardware and software components.

Communication module 2024 can facilitate communication with other devices over one or more external ports 2036 or via EMF circuitry 2008 and includes various software components for handling data received from EMF circuitry 2008 and/or external port 2036.

Graphics module 2028 can include various known software components for rendering, animating and displaying graphical objects on a display surface. In embodiments in which touch I/O device 2012 is a touch sensitive and force sensitive display (e.g., touch screen), graphics module 2028 can include components for rendering, displaying, and animating objects on the touch sensitive and force sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system, also sometimes referred to herein as “GPS”), a music player, and otherwise.

Touch and force-of-touch processing module 2026 can include various software components for performing various tasks associated with touch I/O device 2012 including but not limited to receiving and processing touch input and force-of-touch input received from I/O device 2012 via touch I/O device controller 2032.

System 2000 may further include fingerprint sensing module 2038 for performing the method/functions as described herein in connection with other figures shown and described herein.

I/O subsystem 2006 is connected to touch I/O device 2012 and one or more other I/O devices 2014 for controlling or performing various functions. Touch I/O device 2012 can communicate with processing system 2004 via touch I/O device controller 2032, which includes various components for processing user touch input and force-of-touch input (e.g., scanning hardware). One or more other input controllers 2034 can receive/send electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 can display visual output to the user in a GUI. The visual output may include text, graphics, video, and any combination thereof. Some or all of the visual output may correspond to user-interface objects. Touch I/O device 2012 forms a touch-sensitive and force-sensitive surface that accepts touch input and force-of-touch input from the user. Touch I/O device 2012 and touch screen controller 2032 (along with any associated modules and/or sets of instructions in medium 2001) can detect and track touches or near touches, and where applicable, the force of those touches (and any movement or release of the touch, and any change in the force of the touch) on touch I/O device 2012. Touch I/O device 2012 and touch screen controller 2032 can convert the detected touch input and force-of-touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad or trackpad), the user may indirectly interact with graphical objects that are displayed on a separate display screen embodied as I/O device 2014.

Touch I/O device 2012 may be analogous to the multi-touch sensitive surface described in the following U.S. Pat. Nos.: 6,323,846 (Westerman et al.), 6,570,557 (Westerman et al.), and/or 6,677,932 (Westerman), and/or U.S. Patent Publication 2002/0015024A1, each of which is hereby incorporated by reference.

Embodiments in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other embodiments.

Feedback may be provided by touch I/O device 2012 based on the user's touch, and force-of-touch, input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some embodiments, peripherals interface 2016, one or more processors 2018, and memory controller 2020 may be implemented on a single chip, such as processing system 2004. In some other embodiments, they may be implemented on separate chips.

### Further System Elements

In one embodiment, an example system includes a force sensor connected to the touch I/O device 2012, such as connected to a force sensor controller. For example, the force sensor controller can be included in the I/O subsystem 2006. The force sensor controller can be connected to the processor 2018 and (optionally) the secure processor 2040, with the effect that information from the force sensor controller can be measured, calculated, computed, or otherwise manipulated.

In one embodiment, the force sensor determines a measure of applied force from a user contacting the touch I/O device 2012. The force sensor can provide a signal indicating a measure of applied force.

For example, the force sensor can include an ultrasound-based force measurement system, in which an ultrasonic pulse is generated below a surface of the touch I/O device 2012, and in which the ultrasonic pulse is reflected from that surface of the touch I/O device 2012, with the effect of providing a reflected signal amplitude.

In one embodiment, as described herein, the reflected signal amplitude is responsive to an amount of applied force provided by a user, in which the user contacts the surface of the touch I/O device 2012 (such as by pressing, pushing, or otherwise contacting that surface). In one embodiment, as described herein, the reflected signal amplitude is relatively larger when the amount of applied force provided by the user is relatively larger.

In one embodiment, the force sensor can include one or more force sensing elements, disposed in rows and columns. For example, the force sensor can include a driving signal for each column, which causes one or more ultrasonic pulse generators to emit ultrasonic pulses, which can be reflected from a surface of the touch device (such as a top surface, depending upon orientation of the touch device), and which can be detected by one or more ultrasonic pulse detectors which can detect reflections from that surface.

In one embodiment, the signal provided by the force sensor, or by one or more force sensing elements, can include an analog signal indicating a measure of reflected signal amplitude. However, in the context of the invention, there is no particular requirement for any such limitation. For example, the time varying signal can be encoded using a pulse width coding technique or other pulse coding technique, an analog-to-digital encoding technique or other digital encoding technique, or otherwise.

In one embodiment, a signal measuring the reflected ultrasonic pulse can be responsive to an amount of the surface of the touch device covered by the user's finger. This would have the effect that, if the user's finger is pressed harder against the surface of the touch device, the area of that surface covered by the user's finger would be larger, and the signal responsive to reflection of the ultrasonic pulse would be correspondingly larger (alternatively, would be correspondingly smaller, if the circuit is so disposed).

In one embodiment, the signal provided by the force sensor or by one or more force sensing elements, can be received and processed by a computing device, such as the processor 2018 or (optionally) the secure processor 2040. The processor 2018 or (optionally) the secure processor 2040 can determine, in response to the signal provided by the force sensor, one or more values indicating an amount of force applied by the user.

### Examples of Applied Touch

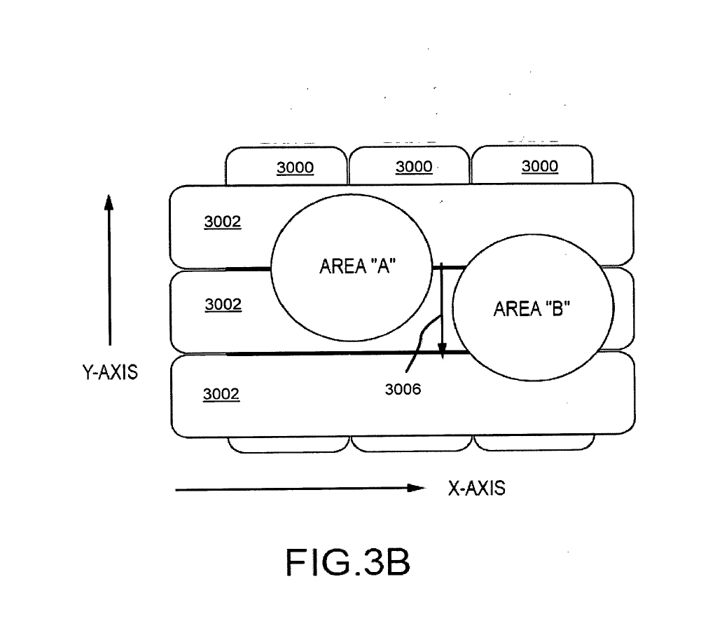

FIG. 3A shows a first conceptual drawing of an applied force being moved from a first location to a second location on a touch device.

As described above, in one embodiment, the force sensor can include one or more force sensing elements, disposed in rows and columns. As shown in the figure, the touch device can include an X axis and a Y axis, with the effect that each location on the touch device is characterized by an X axis value and a Y axis value. In one embodiment, the force sensor can include a set of drive columns 3000, each disposed within a limited portion of the X axis and along substantially the length of the Y axis. In one embodiment, substantially the entire surface of the touch device is covered by drive columns.

Similarly, in one embodiment, the force sensor can include a set of sense rows 3002, each disposed within a limited portion of the Y axis and along substantially the length of the X axis. In one embodiment, substantially the entire surface of the touch device is covered by sense rows. Accordingly, in one embodiment, the force sensor can include a set of force sensing elements, one at the intersection of each row and column, with the effect that the force sensing elements are arranged in a rectilinear array.

When a user's finger or a stylus covers one force sensing element or less, for example, movement of the user's finger or the stylus can cause a change in the measurement of applied force. By way of example only, at times when a user's finger is positioned in alignment with a force sensing element, the user's finger provides a measurement representative of an amount of an ultrasonic signal absorbed by the user's finger above the force sensing element. At times when the user's finger is positioned out of alignment with a force sensing element, the user's finger provides a first measurement for a first force sensing element covered only partially by the user's finger, and a second measurement for a second force sensing element covered only partially by the user's finger.

For example, a first touch position can be indicated by an area “A” and a second touch position is indicated by area “B”. The movement from area “A” to area “B” is represented by an arrow 3004. In such cases, when a touch or force is positioned as indicated by area “A”, force applied, for example, by a user's finger is located in alignment with force sensing elements 3000, 3002. However, when the user's finger is positioned as indicated by area “B”, the force applied by the user's finger is not located in alignment with all of the affected force sensing elements. Instead, the user's finger at area “B” partially covers force sensing elements 3002.

In such cases, when the user's finger moves from the area “A” to the area “B, the measurement of applied force by the user's finger can change in response to that movement, even if the applied force remains the same. For example, as described in further detail with respect to other figures, the measurement of applied force by the user's finger may not be linear with the amount of each force sensing element covered by the user's finger. This has the effect that when only a portion of a force sensing element is covered by the user's finger, the measurement of applied force can be less than the amount of area apportioned to that force sensing element. In some embodiments, even if the measurement of applied force is summed for all such force sensing elements, the total may not be representative of the actual applied force.

This has the effect that spurious changes in the measurement of applied force can occur as the user's finger is moved from the area “A” to the area “B”. Similarly, spurious differences in the measurement of applied force can occur between equal amounts of force applied by the user at the area “A” and the area “B”.

FIG. 3B shows a second conceptual drawing of an applied force being moved from a first location to a second location on a touch device.

When the user's finger covers more than one force sensing element, movement of the user's finger similarly can cause a change in the measurement of applied force. For example, at times when the user's finger is positioned in alignment with one or more force sensing elements, the user's finger may provide a larger measurement of an ultrasonic signal absorbed by the user's finger above those force sensing elements than at times when the user's finger is positioned out of alignment with one or more force sensing elements.

For example, similar to the FIG. 3A, when the user's finger moves from the area “A” to the area “B”, the number of force sensing elements directly in alignment with the user's finger can change between area “A” and area “B”. In the figure, movement is indicated by an arrow 3006 indicating area “B” is offset from area “A” along the Y axis and the X axis. In the context of the invention, however, there is no particular requirement for any such limitation. For example, movement can be along the Y axis alone, along the X axis alone, or along both the Y axis and the X axis.

In such cases, when the user's finger is in the area “A”, approximately four force sensing elements are partially covered. However, when the user's finger is in the area “B”, approximately six force sensing elements are covered, with four sensing elements partially covered. Since, as noted above, when only a portion of each force sensing element is covered, for example, by a user's finger, the measurement of applied force can be less than the amount of area apportioned to that force sensing element, and the total measurement of applied force may differ as the user's finger is moved from the area “A” to the area “B”.

Similar to the effect noted with respect to the FIG. 3A, this has the effect that spurious changes in the measurement of applied force can occur as the user's finger is moved from the area “A” to the area “B”, even if the area “A” and the area “B” are both bigger than an individual force sensing element. Also similar to the effect noted with respect to the FIG. 3A, this also has the effect that spurious differences in the measurement of applied force may occur between equal amounts of force applied by the user at the area “A” and the area “B”.

### Signal Responsive to Applied Force

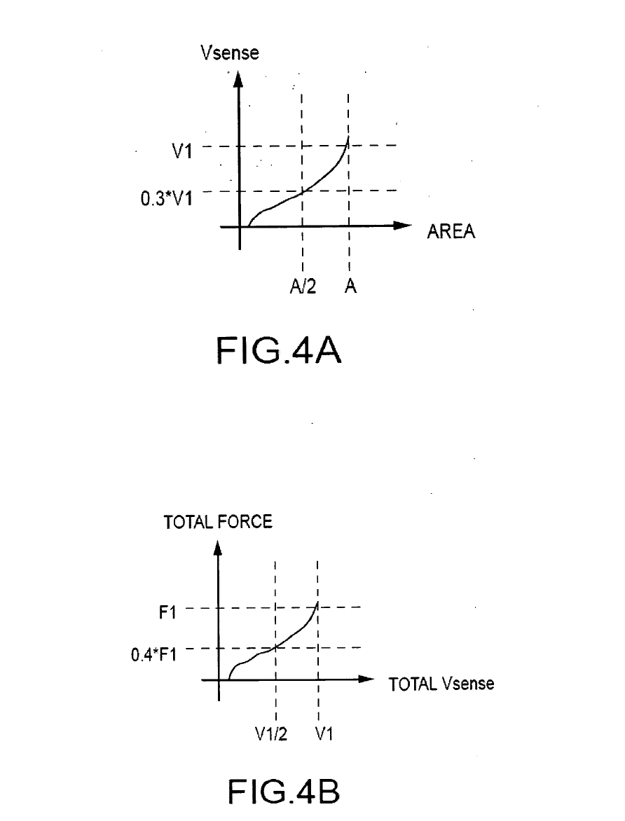

FIG. 4A shows a conceptual drawing of a relationship between an area of applied force to a responsive signal from a force sensing element.

In one embodiment, a measured signal from a force sensing element is responsive to a fixed amount of applied force, and a variable measure of an area of the force sensing element that is covered by the user's finger. As described herein, the measured signal from the force sensing element is responsive to an area of the force sensing element that is covered by the user's finger. In one embodiment, the measured signal from the force sensing element increases nonlinearly with the increase in the area of the force sensing element covered by the user's finger.

For example, where the area of the force sensing element covered by a user's finger is a value A, a voltage representing the measured signal from the force sensing element can be a value V1. In contrast, when the area of the force sensing element covered by the user's finger is a value A/2, even when the amount of applied force is substantially the same, a voltage representing the measured signal from the force sensing element can be a value 0.3*V1, which is substantially less than a linear response of V1/2. This has the effect that, when the user's finger covers two separate force sensing elements, each with area A/2, the total measured signal is only about 0.6*V1 (that is, twice 0.3*V1), which is substantially less than when the user's finger covers a single force sensing element with area A.

FIG. 4B shows a conceptual drawing of a relationship between a signal from a force sensing element and a measurement of applied force.

In one embodiment, a measured signal from a force sensing element is determined in response to an area of the force sensing element that is covered by a touch (e.g., by a user's finger). For example, using a location sensor to determine an area of the force sensing element that is covered by the user's finger, and a calibration method (such as obtaining a measure of force in response to a user interface, or in response to a request to the user to apply a selected amount of force), the touch device 2012 can determine a transfer function from the area of the force sensing element that is covered by the user's finger and the finger's location to a determination of the amount of applied force. This has the effect that a derived measure of applied force, as determined in response to a force sensing element, is responsive to a measured signal from that force sensing element, as determined in response to a measured signal from a force sensing element responsive to the user's finger. In one embodiment, the derived measure of applied force increases nonlinearly with the measured signal from the force sensing element determined in response to the user's finger.

For example, where the measured signal from the force sensing element is a value V1, the derived measure of applied force can be a value F1. In contrast, when the measured signal from the force sensing element is a value V1/2, again, in response to an area of the force sensing element covered by the user's finger, the derived measure of applied force can be a value 0.4*F1, which is substantially less than a linear response of F1/2. This has the effect that, when the user's finger covers two separate force sensing elements, even if each provides a measured signal from the force sensing element of voltage V1/2, the total measured applied force is only about 0.8*F1 (that is, twice 0.4*F1), which is substantially less than when the user's finger covers a single force sensing element and provides a measured signal from the force sensing element of voltage V1.

In both such cases, simply summing or otherwise simply combining the signals from the separate force sensing elements covered by the user's finger, when there is more than one such force sensing element, may not provide an accurate representation of the amount of applied force provided by the user. This has the effect that if the user applies force in a location directly aligned with (one or more) force sensing elements, the measure of applied force will be different, such as relatively greater, than if the user applies force in a location not directly aligned with force sensing elements.

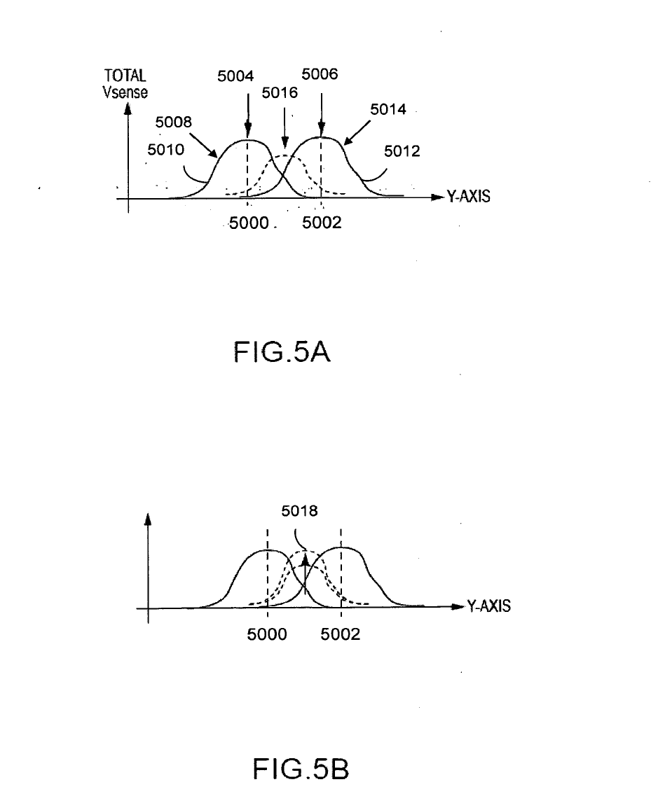

FIG. 5A shows a conceptual drawing of an uncorrected measure of force applied to a touch device.

As described herein, when the user's finger is positioned in alignment with, such as directly over, a first force sensing element (point 5000) or a second force sensing element (point 5002), a measured signal Vsense from the force sensing element which the user's finger is directly aligned with is substantially maximized (5004, 5006). This has the effect that the total measured signal “total Vsense” from all force sensing elements near the user's finger is also substantially maximized when the user's finger is directly above a center of the first force sensing element. As the user's finger is moved, or otherwise located, to one side of directly aligned with the first force sensing element, the individual measured signal Vsense from the first force sensing element is decreased, and the total measured signal “total Vsense” is also decreased.

For example, the total measured signal “total Vsense” may be decreased with respect to a curve 5008 (e.g., as represented by region 5010 in curve 5008). The amount of the total measured signal “total Vsense” is decreased substantially relatively more as the user's finger is moved, or otherwise located, relatively farther from a center of the first force sensing element (point 5000). Similarly, the amount of the total measured signal “total Vsense” is relatively maximized 5006 when the user's finger is located directly in alignment with (such as directly above) the second force sensing element (point 5002), and the amount of the total measured signal “total Vsense” is decreased substantially relatively more as the user's finger is moved, or otherwise located, relatively farther from a center of the second force sensing element (e.g., as represented by region 5012 in curve 5014).

However, as noted above, the amount of the measured signal Vsense is reduced nonlinearly with the area of any force sensing element covered by the user's finger. This has the effect that the total measured signal “total Vsense”, when the user's finger is not aligned with either the first force sensing element or the second force sensing element, may be relatively less than the total measured signal “total Vsense” when the user's finger is in fact substantially aligned with either the first force sensing element or the second force sensing element. As shown in the figure, the total measured signal “total Vsense” 5016 (as represented by the dotted line), is relatively less than the total measured signal “total Vsense”, with respect to either curve 5008 or curve 5014.

FIG. 5B shows a conceptual drawing of a corrected measure of force applied to a touch device.

As described herein, when the applied force (e.g., user's finger) is not aligned with any one force sensing element, the total measured signal “total Vsense” may be relatively less than the total measured signal “total Vsense” when the force is in fact substantially aligned with one or more force sensing elements. In one embodiment, the touch device 2012 can apply an adjustment or correct to the total measured signal “total Vsense” when the applied force is not aligned with any one force sensing element (see curve 5018).

In one embodiment, the touch device 2012 can determine a total measured signal “total Vsense” for a selected applied force, such as using a user interface to request the user to provide a selected and fixed amount of applied force. The touch device 2012 can also determine a touch location, such as where the applied force is actually being applied to the touch device 2012. When touch device 2012 knows the actual amount of the applied force and the location of that applied force, it can determine whether or not a correction to the total measured signal “total Vsense” is needed for that selected applied force. For example, if the touch device 2012 determines, such as in response to a location signal, that the applied force is being applied in direct alignment with a force sensing element, the touch device 2012 can determine that no substantial correction to the total measured signal “total Vsense” is needed for that selected applied force. In contrast, if the touch device 2012 determines, such as in response to a location signal, that the applied force is being applied other than in alignment with a force sensing element, the touch device 2012 can determine that a correction to the total measured signal “total Vsense” is needed for that selected applied force.

In one embodiment, the touch device 2012 can determine whether the applied force is being applied in alignment with, or other than in alignment with, a force sensing element, in response to a touch sensor. In one embodiment, the touch sensor includes a capacitive touch sensor, such as a capacitive touch sensor having one or more touch sensing elements. A capacitive touch sensor having one or more touch sensing elements can determine a location where the user's finger is in contact, or near contact, with the touch device 2012, in response to a measure of capacitance between the capacitive touch sensor and the user's finger (or another user body part such as the user's hand, or another device such as a brush or stylus). For example, the capacitive touch sensor can determine one or more touch sensing elements at which the user's finger is in contact, or near contact, with the touch device 2012.

In one embodiment, the capacitive touch sensor identifies the one or more touch sensing elements at which the user's finger is in contact, or near contact, with the touch device 2012. In response thereto, the touch device 2012 determines whether the applied force from the user's finger is located in alignment with, or not in alignment with, one or more of the force sensing elements. In response thereto, the touch device 2012 determines whether a correction to the total measured signal “total Vsense” is needed for that selected applied force, and if so, how much of a correction should be applied.

In one embodiment, the touch device 2012 determines an amount of correction to the total measured signal “total Vsense” in response to the location of the applied force, as determined by the capacitive touch sensor. The capacitive touch sensor determines where the applied force is being applied, that is, in response to activation of one or more touch sensing elements. For example, the touch device 2012 can determine a centroid of the locations of those touch sensing elements which are activated, and identify the touch location in response to that centroid. This would be most applicable if those touch sensing elements were relatively nearby, with the effect that the centroid of their locations would be a reasonable identification of a centerpoint of a single touch, versus if those touch sensing elements were relatively distant, with the effect that the centroid of their locations can indicate a spot that was between two separate touch locations (such as if the user were contacting the touch device 2012 with two separate fingers, such as with a two-finger gesture).

If the touch location is directly above (that is, in alignment with) one or more force sensing elements, the touch device 2012 can determine that no substantial correction is required for the total measured signal “total Vsense”. In contrast, if the touch location is not in alignment with any force sensing elements, the touch device 2012 can determine that a correction is desirable for the total measured signal “total Vsense”. In the latter case, the touch device 2012 can determine an amount of correct that is desirable, such as in response to how far away from alignment with the force sensing elements that touch location actually is.

In one embodiment, the touch device 2012 determines a touch location, and for each of the one or more force sensing elements responding to applied force, determines a correction that is desirable in response to distance from that touch location. For example, on a touch device 2012 having a relatively flat surface, the touch device 2012 can determine a two-dimensional (2D) Euclidean distance from the touch location, and can adjust the individual values of Vsense for each of the one or more force sensing elements in response to its individual distance from that touch location. Once each of the individual values of Vsense is adjusted, the touch device 2012 can combine the individual values of Vsense, such as by summing them to provide a total measured signal “total Vsense”.

### Method of Operation

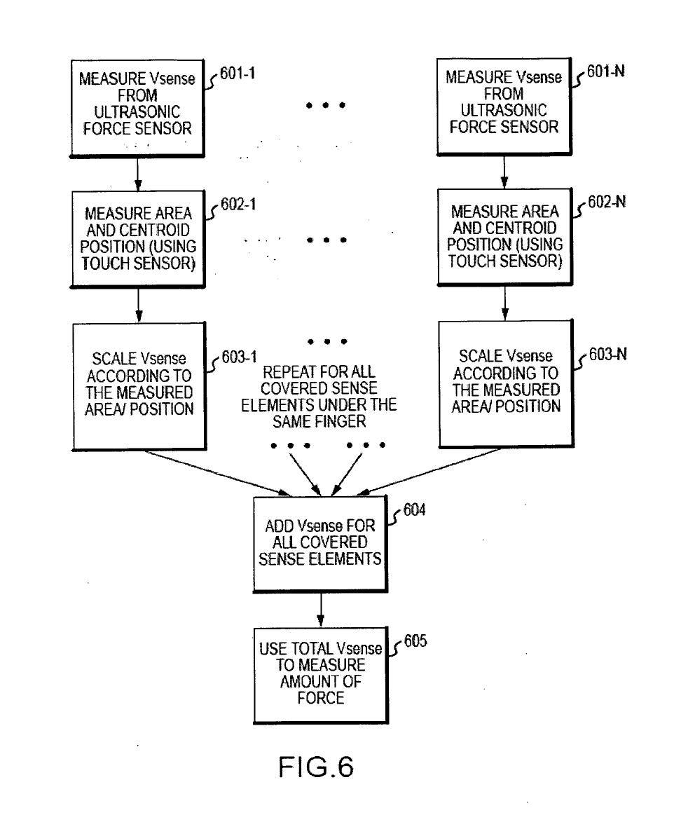

FIG. 6 shows a conceptual drawing of a method of operation.

The method includes a set of flow points and a set of method blocks. Although the flow points and method blocks are shown in the figure in a sequential order, in the context of the invention, there is no particular requirement for any such limitation. For example, the method blocks can be performed in a different order, in parallel or in a pipelined manner, or otherwise.

Similarly, although the method is described as being performed by the processor 2018, in the context of the invention, there is no particular requirement for any such limitation. For a first example, the method can be performed, at least in part, by the secure processor 2040, by another element of the touch device 2012, by an element external to the touch device 2012, by some combination or conjunction thereof, or otherwise. For a second example, the method can be performed, at least in part, by circuitry or other specialized hardware configured to operate as described with respect to the method steps, or configured to operate on signals such as those responsive to one or more force sensing elements.

At a set of steps 601-1 through 601-N, the processor 2018 measures an individual value for Vsense, the sensed signal from the ultrasonic force sensing element, for each one of the force sensing elements 1 through N covered, at least in part, by the applied force (e.g., user's finger). For example, steps 601-1 through 601-N can each correspond to force sensing elements 1 through N, as identified by the touch location sensor.

At a set of steps 602-1 through 602-N, the method measures an area covered by the applied force (e.g., user's finger), for each one of the force sensing elements 1 through N described above. At this step, the method also determines a centroid of the force sensing elements 1 through N. In alternative embodiment, the method can instead determine a centroid of those force sensing elements 1 through N, where the location of each of those force sensing elements is weighted by the area covered by the applied force for the corresponding force sensing element.

At a set of steps 603-1 through 603-N, the method determines a scaled value of Vsense, for each one of the force sensing elements 1 through N described above. In one embodiment, the scaled value of Vsense is determined in response to the measured area for the corresponding force sensing element, and in response to a computed distance of the corresponding force sensing element from the centroid determined in the step 602-1 through 602-N.

For example, in one embodiment, a scaling factor for V'sense, a scaled value of Vsense, can be determined empirically in response to area and distance, and maintained in a lookup table, with the effect that V'sense=f (Vsense, Area, Position), where the function f includes multiplying by a scaling factor from a lookup table in response to Area and Position, where Area indicates a fraction of the force sensing element covered by the user's finger, as indicated by the location provided by the touch sensor, and where Position indicates a Euclidean distance between a center of the force sensing element and the centroid determined in the step 602-1 through 602-N.

At a step 604, the method combines the values for V'sense for all covered force sensing elements. For example, the method can compute the sum of all such V'sense values, to provide a value V*sense.

At a step 605, the method determines a measure of applied force in response to the combined value V*sense determined in the step 604. For example, in one embodiment, the method can determine an applied force that would provide the value V*sense when measured at a single force sensing element.

In one embodiment, the force sensor reports the applied force as the amount determined in the step 605, and the method is repeated for the next amount of applied force. For example, the method can be repeated periodically (such as every few milliseconds), in response to a system event (such as a new touch by the user applied to the touch device 2012), in response to a user request, aperiodically or otherwise from time to time, some combination or conjunction thereof, or otherwise.

While the method is primarily described herein with respect to a signal responsive to an ultrasonic sensor, in the context of the invention, there is no particular requirement for any such limitation. For example, the method can be used with respect to a signal from a different type of sensor, such as a different type of force sensor.

Certain aspects of the embodiments described in the present application may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

1. An electronic device, comprising:
a touch device including one or more force sensors, the force sensors including one or more force sensing elements, each of the one or more force sensing elements adapted to provide one or more signals with respect to a force applied to the touch device; and
one or more processors having access to the one or more signals, the one or more processors adapted to determine a corrected signal for at least one of the one or more signals when a force is applied at one or more locations that is not directly aligned with the force sensing elements.

2. The electronic device as in claim 1, further comprising one or more touch sensors, the touch sensors including one or more touch sensing elements.

3. The electronic device as in claim 2, wherein said one or more processors are adapted to determine the one or more locations for the applied force.

4. The electronic device as in claim 2, wherein at least one force sensor comprises an ultrasonic force sensor, the ultrasonic force sensor including an ultrasonic pulse detector and an ultrasonic pulse generator adapted to emit ultrasonic pulses.

5. The electronic device as in claim 4, wherein at least one signal comprises a signal measuring a reflected ultrasonic pulse.

6. The electronic device as in claim 1, wherein at least one force sensor comprises a capacitive force sensor, and wherein at least one signal comprises a signal measuring a capacitance.

7. The electronic device as in claim 1, wherein at least one force sensor comprises an inductive force sensor, and wherein at least one signal comprises a signal measuring an inductance.

8. The electronic device as in claim 1, wherein the one or more signals are based on an area of at least one force sensing element that is covered by an object applying the force.

9. The electronic device as in claim 8, wherein the corrected signal comprises a scaled signal.

10. The electronic device as in claim 1, wherein the force applied at one or more locations is not directly aligned with the force sensing elements when the force is applied to only a portion of at least one force sensing element.

11. A method of operating a touch device, comprising:
receiving a signal for a force applied to a force sensing element;
determining a location for the force applied to the force sensing element;
determining whether the force applied to the force sensing element is in alignment with the force sensing element based on the determined location; and
if the force is not in alignment with the force sensing element, correcting the signal for the force applied to the force sensing element.

12. The method as in claim 11, wherein correcting the signal for the force applied to the force sensing element comprises determining a scaled signal for the force sensing element.

13. The method as in claim 11, wherein the force sensing element includes an ultrasonic force sensor that includes an ultrasonic pulse detector and an ultrasonic pulse generator adapted to emit ultrasonic pulses, and wherein determining a signal for a force applied to a force sensing element comprises measuring a reflected ultrasonic pulse for a force applied to a force sensing element.

14. The method as in claim 11, wherein the force sensing element includes a capacitive force sensor, and wherein determining a signal for a force applied to a force sensing element comprises measuring a capacitance for a force applied to a force sensing element.

15. The method as in claim 11, wherein the force sensing element includes a resistive force sensor, and wherein determining a signal for a force applied to a force sensing element comprises measuring a resistance for a force applied to a force sensing element.

16. The method as in claim 11, wherein determining whether the force applied to the force sensing element is in alignment with the force sensing element comprises determining whether the force is applied to only a portion of the force sensing element.

17. The method as in claim 11, wherein determining a signal for a force applied to a force sensing element comprises determining a signal for a force applied to a force sensing element based on an area of at least one force sensing element that is covered by an object applying the force.

18. A method of operating a touch device, comprising:
receiving one or more signals for a force applied to the touch device;
receiving one or more locations for the force applied to the touch device;
determining whether the force applied to the touch device is in alignment with one or more force sensing elements based on the one or more locations;
if the force is not in alignment with at least one force sensing element, correcting at least one signal for the force applied to the touch device;
combining the one or more signals and the at least one corrected signal; and
determining a measure of applied force in response to the combined signals.
